(19) United States
(12) Patent Application Publication
(10) Pub. No.: US 2005/0111841 A1
(43) Pub. Date: May 26, 2005

(54) Device for influencing light for illuminating sets for movies, photography, theater, and/or stage

(76) Inventor: Wolfgang-Peter Geller, Garlstorf (DE)

Correspondence Address: Friedrich Kueffner, 317 Madison Avenue, Suite 910, New York, NY, 10017, US

(21) Appl. No.: 10/971,695

(22) Filed: Oct. 22, 2004

(30) Foreign Application Priority Data
Oct. 24, 2003 (DE) 203 16 399.0

(51) Int. Cl. G03B 15/02

(52) U.S. Cl. 396/4

(57) ABSTRACT

A device for influencing light for illuminating a set for filming, photography, theater and/or stage includes a frame and a first carrier layer mounted on the frame. The first carrier layer is essentially transparent to the light used for illuminating the set. At least on selected areas of the first carrier layer, a layer of a material which is impermeable and/or partially permeable to the light used for illuminating the set is arranged.

### BACKGROUND OF THE INVENTION

1. Field of the Invention

The present invention relates to a device for influencing the light used for illuminating a set for taking movies, for photography shoots, for theater and/or stage.

2. Description of the Related Art

When filming movies or taking photographs, it is necessary to illuminate the scene to be recorded, the so-called set, in a suitable manner. For this purpose, not only the natural light is used in most cases, but artificial light sources are used or the sunlight is influenced by means of reflectors or other auxiliary means in such a way that an illumination of the set is achieved which is appropriate and correct with respect to considerations of photography and art.

A frequent problem when taking photographs or movies, but also in theaters or on other stages, is that the light should not cast on the scene too uniformly, since otherwise the scene appears “flat” and the illumination uninspired. For this purpose, the light is directed in a targeted manner, for example, by means of reflectors or spotlights. It is also known in the art to simulate an illumination provided with various shade structures, such as they occur naturally, for example, under a lightly overcast sky or under a tree, by placing masks in the light ray of the light source (sunlight, artificial light). These masks consist of wood boards or metal or plastic plates which are provided with openings, for example, by punching or sawing, arranged in accordance with the desired light patterns. When using such template-like masks, relatively good light effects are achieved. However, this solution has the disadvantage that a separate mask must be manufacture for each desired light situation. The mask cannot usually be used for other situations.

Other masks provided with openings, for example, of fabric, are also conceivable. However, these masks have the same deficiencies.

It is also known in the art to use frames with translucent fabric webs stretched in the frames in order to make the light more diffuse. These fabric webs are tightly stretched in the frames, and the light is uniformly weakened over the surface area.

### SUMMARY OF THE INVENTION

Therefore, it is the primary object of the present invention to further develop a device of the above-described type in such a way that various lighting situations can be produced in a simple and inexpensive manner. In other words, the device should be reusable for various lighting situations and should be easily adaptable.

In accordance with the present invention, the device for influencing the illumination of sets for movie recordings, photography, theater and/or stage includes a frame and a carrier web arranged in the frame which is partially permeable to the light used for illuminating the set. Placed on this carrier layer is at least in selected areas thereof a layer of a material which is impermeable and/or partially permeable to the light used for illuminating the set.

The “frame” does not have to be a rigid frame. Rather, the frame may also be formed of, for example, support belts which surround the first carrier layer. Consequently, the frame can also be called an enclosure. In the case of a frame formed of support belts, this frame, in turn, can be mounted in a rigid frame composed of metal, plastic, wood, or similar ledges. However, the frame can also be suspended or tensioned, for example, directly between two buildings or similar fastening points.

The first carrier layer may be, for example, a transparent net or a transparent foil. The first carrier layer is arranged so as to be smooth in the frame. The carrier layer can contribute generally to the weakening of the light, however, but will usually not contribute to the illumination situation in the sense of a specific light/shade pattern. The layer of a material which is permeable and/or partially permeable to the light used for illuminating the set is placed on this first carrier layer and is secured to a certain extent in this manner.

By suitably arranging and possibly layering the layer of the material which is impermeable and/or partially permeable to the light used for illuminating the set, it is possible to create an illumination which recreates a naturally occurring example, which is artistically acceptable with respect to art, and which varies in its intensity.

In accordance with another feature, an essentially transparent second carrier layer can be provided which can be mounted in the frame in such a way that the layer of the material which is placed between the first and second carrier layers and is held in the folded state by the carrier layers. This second carrier layer can correspond with respect to its material to the first carrier layer and is essentially completely translucent. This second carrier layer can also contribute to the weakening of the light, however, this second carrier layer will usually not contribute to the illumination situation with respect to light/shade patterns.

According to a feature of the present invention, the layer of the material which is impermeable and/or partially permeable to the light used for illuminating the set is a fabric web or a similar flexible layer, for example, a translucent foil, which is arranged in a frame, wherein the fabric web or similar layer has a greater surface area than the inner area of the frame located within the frame. This means that the fabric web or similar layer can be folded at freely selectable locations and can be arranged in double or multiple layers.

The fabric web or similar layer is partially light-permeable for the light being used which may be artificial light or sunlight. This means that a significant portion of the light travels through the fabric, while a portion is held back or reflected or absorbed. Since a portion of the light can already not pass through the fabric web or similar layer when the fabric web is only present in a single layer, by arranging the fabric web or similar layer in double or multiple layers, it is possible to produce a reduced permeability for the light. Consequently, in the scene below or underneath the device, there are locations which are more or less fully illuminated. This results in an illumination situation which reproduces light and shade.

The device according to the present invention is very flexible because the quantity or location of light passing through the fabric and, thus, the illumination situation can be determined by a simple arrangement of the fabric in one or more layers. The illumination situation can be corrected even during filming by rearranging the folds or warpings.

In addition, after the end of recording in a certain illumination situation, the device can be reused for effecting different illumination situations. For this purpose, it is only necessary to rearrange the folding pattern of the material web or similar layer.

In accordance with another embodiment, the layer of the material which is impermeable and/or partially permeable to the light used for illuminating the set is a layer composed of torn and/or cut paper pieces, fabric pieces, and/or pieces of a similar material which is impermeable and/or partially permeable to the light used for illuminating the set and/or of an essentially flat natural material, for example, leaves and/or feathers.

In this manner, it is possible with simple means, for example, with the use of natural leaves or artificial leaves made of paper or a simple material, to recreate the light situation as it occurs naturally under a tree. Using comparable means, it is possible to recreate similar natural illumination situations, or to create simple artistically interesting light aspects without natural examples.

The material placed on the carrier layer, for example, the folds or warpings adjusted in the fabric web or similar layer or the pieces or natural materials placed on the material, can be secured by means of staple threads, plastic label threads, or the like for a certain recording situation.

While specific embodiments of the invention have been shown and described in detail to illustrate the inventive principles, it will be understood that the invention may be embodied otherwise without departing from such principles.

### BRIEF DESCRIPTION OF THE DRAWING

In the drawing:

FIG. 1 is a schematic top view of a device according to the present invention;

FIG. 2 is a schematic perspective view, partially in section, of the device of FIG. 1;

FIG. 3 is a schematic top view of a second embodiment of the device according to the present invention;

FIG. 4 is a schematic perspective view, partially in section, of the device of FIG. 2.

### DETAILED DESCRIPTION OF THE INVENTION

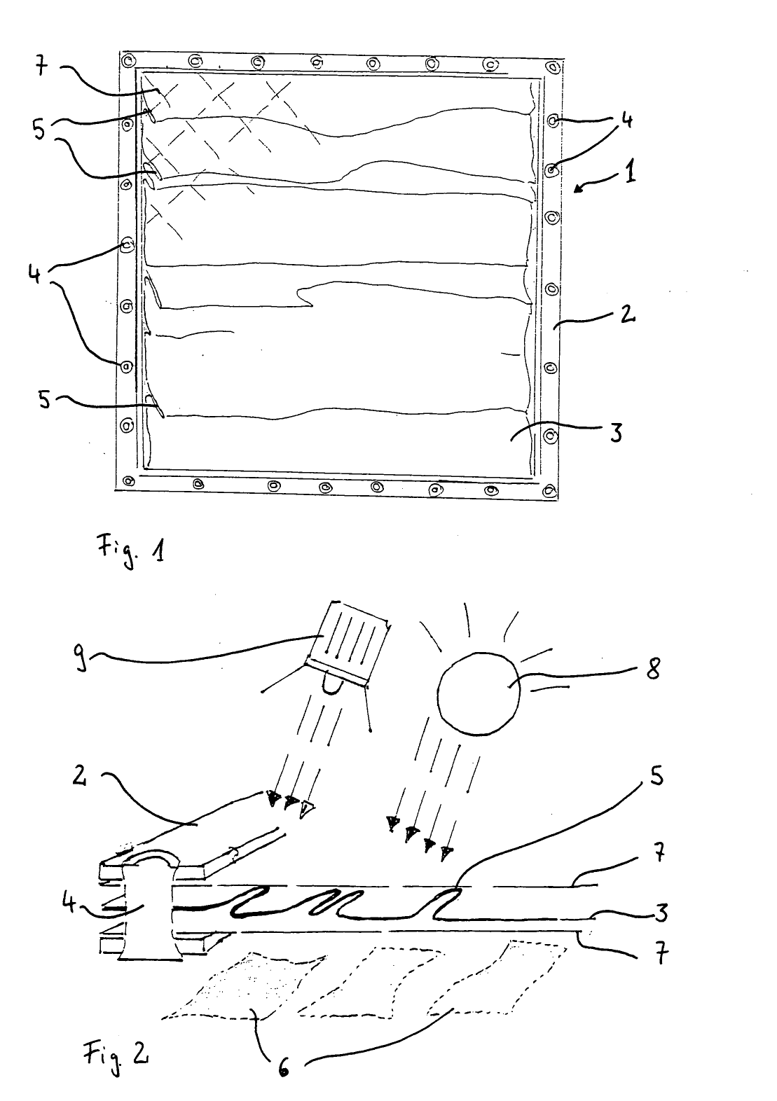

FIG. 1 shows in a schematic top view a device 1 according to the present invention for influencing light. The device 1 has a frame 2 which defines the device 1. In the illustrated embodiment, the frame 2 is formed of relatively flexible support belts. A fabric web 3 is arranged in the frame 2. The support belts forming the frame 2 are provided with eyelets 4 by means of which the belt frame can be secured, for example, within a rigid frame or in a desired position on fixed points of, for example, buildings.

The fabric web 3 has a greater surface area than the inner surface defined by the frame 2. This makes it possible, as illustrated in the drawing, to fold the fabric web or provide it with warpings 5. The fabric web 3 is partially permeable to light used for illuminating the set. However, the fabric web 3 absorbs or reflects at least a small portion of the light so that by arranging the fabric web in multiple layers a reduced light permeability of the device can be achieved at the locations of the warpings 5. This results in less illuminated shade locations 6 in the illumination provided by the device, as seen in FIG. 2.

The warpings or folds 5 can be freely arranged by an operator so that the illumination of a set by means of the device 1 can be variable and can be adapted to natural illumination conditions. To secure the warpings or folds 5 in the once arranged position, the fabric web can be stapled or sewn with a few stitches in the selected configuration.

However, in accordance with a preferred feature, the fabric web 3 is secured in its position by means of carrier layers 7, shown in criss-cross shading in FIG. 1, arranged below and above the fabric web 3. These carrier layers 7 are transparent to the light used as much as possible and can be realized, for example, by means of nets or foils. However, it is also possible to use specifically those carrier layers which weaken the light used in the desired manner, which filter the light in one color or weaken the light in some other manner.

In practice, the fabric web 3 is arranged on a first carrier layer 7 with the warpings or folds 5 required for the desired illumination and the fabric web 3 is subsequently covered and secured by means of the second carrier layer 7.

Finally, the illustration of a sun 8 or an artificial light 9 in FIG. 2 is intended to indicate that the device can be used with natural sunlight as well as with artificial light.

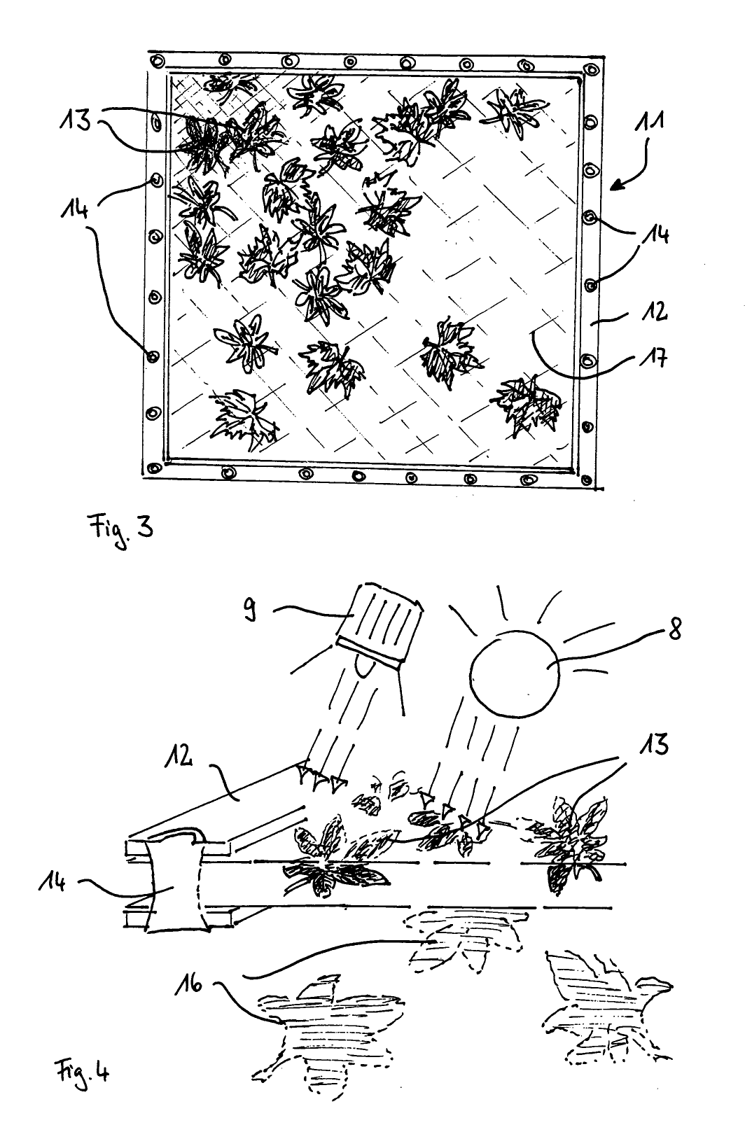

FIGS. 3 and 4 of the drawing show a second embodiment of the device 11 according to the present invention for influencing light. This device 11 also includes a frame 12 which defines the device 11. In this embodiment, the frame 12 is also formed of relatively flexible support belts. The support belts which form the frame 12 are provided with eyelets 14 by means of which the frame formed by the belts can be secured, for example, within a rigid frame or in a desired position at fixed points of, for example, buildings. A first support layer and a second support layer 17 are arranged in the frame 12.

In this second embodiment, the leaves 13 are arranged between these carrier layers 17. These leaves 13 are only partially permeable to the light used for illuminating the set. The leaves absorb or reflect at least a small portion of the light, so that a reduced light permeability of the device can be achieved at those locations where the leaves are placed. By stacking several layers on top of each other, this effect can be amplified. The result are less illuminated shade areas 16 underneath the device.

The arrangement of the leaves 13 can be freely modified by a light engineer, so that the illumination of a set can be made variable by means of the device 11 and can be adapted to natural light conditions. Once the leaves 13 have been arranged as desired, they can be secured to the carrier layer 17 by stapling or can be sewed on with a few stitches. In addition, the leaves 13 are secured by means of the carrier layers 17 arranged above and below the leaves 13, as indicated by crisscross hatching in FIG. 3. These carrier layers are equivalent to the carrier layers 17 described above.

In practice, the leaves 13 are arranged on a first carrier layer 17 for achieving the desired illumination, and are subsequently covered by the second carrier layer 17 and may additionally be secured by means of stapling or the like.

The illustration of a sun 8 or an artificial light 9 in FIG. 4 once again is intended to indicate that the device 11 can be used with natural sunlight as well as with artificial light.

In principle, the size of the device is freely selectable. However, the size of the device must be such that the entire set is covered with respect to illumination.

The device according to the present invention makes it possible in a simple manner to provide an illumination of a movie or photography set which is flexibly arrangeable and resembles natural illumination conditions.

While specific embodiments of the invention have been shown and described in detail to illustrate the inventive principles, it will be understood that the invention may be embodied otherwise without departing from such principles.

1. A device for influencing light for illuminating a set for filming, photography, theater and/or stage, the device comprising a frame, and a first carrier layer mounted on the frame, wherein the first carrier layer is essentially transparent to the light used for illuminating the set, and wherein on at least selected areas of the first carrier layer is arranged a layer of a material which is impermeable and/or partially permeable to the light used for illuminating the set.

2. The device according to claim 1, comprising a second carrier layer of a material essentially transparent to the light used for illuminating the set, wherein the second carrier layer is mountable in the frame such that the layer of the material which is impermeable and/or partially permeable to the light used for illuminating the set is arranged between the first carrier layer and the second carrier layer and is secured in its position by the carrier layers.

3. The device according to claim 1, wherein the frame is comprised of support belts connected to one another to form an enclosure, wherein at least the first carrier layer is secured to the frame.

4. The device according to claim 1, wherein the layer of the material which is impermeable and/or partially permeable to the light used for illuminating the set is a fabric web or similar flexible layer which is partially permeable to the light used for illuminating the set, wherein the fabric web or similar layer has a surface area which is greater than the inner area within the frame and can be arranged in several layers by folding or warping the layer, so that in those areas in which the fabric web or similar layer is present in two or more layers, more light is absorbed than in the areas in which the fabric is present in a single layer.

5. The device according to claim 1, wherein the layer of the material which is impermeable and/or partially permeable to the light used for illuminating the set is a layer of torn and/or cut paper pieces, fabric pieces, and/or pieces of a similar material which is impermeable and/or partially permeable to the light used for illuminating the set and/or is formed of essentially flat natural materials.

6. The device according to claim 5, wherein the flat natural materials are leaves or feathers.

7. The device according to claim 1, wherein the layer of a material which is impermeable and/or partially permeable to the light used for illuminating the set is attached at least to the first carrier layer.
